(19) United States
(12) Patent Application Publication
(10) Pub. No.: US 2015/0331949 A1
(43) Pub. Date: Nov. 19, 2015

(54) SYSTEM AND METHOD FOR DETERMINING CURRENT PREFERENCES OF A USER OF A USER DEVICE

(71) Applicant: Cortica, Ltd., Tel Aviv (IL)

(72) Inventors: Igal Raichelgauz, New York, NY (US); Karina Odinaev, New York, NY (US); Yehoshua Y. Zeevi, Haifa (IL)

(73) Assignee: CORTICA, LTD., TEL AVIV (IL)

(21) Appl. No.: 14/811,227

(22) Filed: Jul. 28, 2015

Related U.S. Application Data
(63) Continuation-in-part of application No. 12/348,888, filed on Jan. 5, 2009.
Application No. 12/348,888 is a continuation-in-part of application No. 12/084,150, filed on Apr. 7, 2009, now Pat. No. 8,655,801.
Application No. 12/348,888 is a continuation-in-part of application No. 12/195,863, filed on Aug. 21, 2008, now Pat. No. 8,326,775.
Application No. 12/195,863 is a continuation-in-part of application No. 12/084,150, filed on Apr. 7, 2009, now Pat. No. 8,655,801.
(60) Provisional application No. 62/030,080, filed on Jul. 29, 2014.

(30) Foreign Application Priority Data
Oct. 26, 2005 (IL) 171577
Jan. 29, 2006 (IL) 173409
Aug. 21, 2007 (IL) 185414

(51) Int. Cl. G06F 17/30

(52) U.S. Cl. CPC G06F 17/30864; G06F 17/301

(57) ABSTRACT

A method and system for determining current preferences of a user of a user device respective of a metadata to a user device are provided. The method includes receiving at least one input multimedia content element from the user device; receiving at least one query; generating at least one signature respective of the at least one input multimedia content element; searching a storage unit for a multimedia content element matching the at least one input multimedia content element, wherein the matching is performed respective of the at least one generated signature and the at least one query; retrieving metadata associated with the matching multimedia content element, wherein the metadata implies the current preferences of the user; and displaying the metadata on a display of the user device.

### CROSS-REFERENCE TO RELATED APPLICATIONS

This application claims the benefit of U.S. Provisional Application 62/030,080 filed on Jul. 29, 2014. This application is also a continuation-in-part application of U.S. patent application Ser. No. 12/348,888 filed Jan. 5, 2009, now pending. The Ser. No. 12/348,888 application is a continuation-in-part of:

(1) U.S. patent application Ser. No. 12/084,150 filed on Apr. 7, 2009, now U.S. Pat. No. 8,655,801, which is the National Stage of International Application No. PCT/IL2006/001235, filed on Oct. 26, 2006, which claims foreign priority from Israeli Application No. 171577 filed on Oct. 26, 2005 and Israeli Application No. 173409 filed on 29 Jan. 2006; and

(2) U.S. patent application Ser. No. 12/195,863, filed Aug. 21, 2008, now U.S. Pat. No. 8,326,775, which claims priority under 35 USC 119 from Israeli Application No. 185414, filed on Aug. 21, 2007, and which is also a continuation-in-part of the above-referenced U.S. patent application Ser. No. 12/084,150. All of the applications referenced above are herein incorporated by reference.

### TECHNICAL FIELD

The present disclosure relates generally to the analysis of multimedia content, and more specifically to a system for providing metadata respective of multimedia content.

### BACKGROUND

As technology advances, users desire more information with greater accuracy and quicker delivery. One technique for delivering accurate information is to determine what type of information the user prefers relative to specific multimedia content items.

Current solutions provide several tools to identify users' preferences. Some current solutions actively require an input from the users to specify their interests. These solutions generate profiles based on the received inputs. However, profiles generated for users based on their inputs may be inaccurate as the users tend to provide only their current interests, or only partial information due to their privacy concerns.

Other current solutions passively track the users' activity through particular websites such as social networks. The disadvantage with such solutions is that typically only limited information regarding the users is revealed, as users tend to provide only partial information on social networks due to privacy concerns. For example, users creating an account on Facebook® typically provide only the mandatory information required for the creation of the account. Therefore, solutions which track users' activity through particular websites are not properly configured to determine a user's preference for information related to specific items.

### SUMMARY

A summary of several exemplary embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later. For convenience, the term some embodiments may be used herein to refer to a single embodiment or multiple embodiments of the disclosure.

Certain embodiments include a method for determining current preferences of a user of a user device. The method comprises: receiving at least one input multimedia content element from the user device; receiving at least one query; generating at least one signature respective of the at least one input multimedia content element; searching a storage unit for a multimedia content element matching the at least one input multimedia content element, wherein the matching is performed respective of the at least one generated signature and the at least one query; retrieving metadata associated with the matching multimedia content element, wherein the metadata implies the current preferences of the user; and displaying the metadata on a display of the user device.

Certain embodiments include a system for determining current preferences of a user of a user device. The system comprises: an interface; a storage unit; a processing unit; a memory, the memory contains therein instructions that when executed by the processing unit configures the system to: receive by the interface at least one input multimedia content element from the user device; receive at least one query; search a storage unit for a multimedia content element matching the at least one input multimedia content element, wherein the matching is performed respective of the at least one generated signature and the at least one query; retrieve metadata associated with the matching multimedia content element, wherein the metadata implies the current preferences of the user; and, display the metadata on a display of the user device.

### BRIEF DESCRIPTION OF THE DRAWINGS

The subject matter that is regarded as the disclosed embodiments is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic block diagram of a user device configured to perform the various embodiments disclosed herein.

FIG. 2 is a flowchart depicting a method of displaying content associated with multimedia content elements according to one embodiment.

FIG. 3 is a block diagram depicting the basic flow of information in the signature generator system according to one embodiment.

FIG. 4 is a diagram showing the flow of patches generation, response vector generation, and signature generation in a large-scale speech-to-text system according to one embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

Certain exemplary embodiments disclosed herein provide a system and method that determine the current preferences of a user based on a multimedia content element and a query provided by the user. Specifically, the metadata associated with multimedia content element, or portions thereof is determined. In an embodiment, at least one signature is generated for each multimedia content element received, or a portion thereof. At least one query respective of the multimedia content element is further received by an interface of the user device. Then, respective of the signatures and the at least one query, content associated with the multimedia content element is extracted from a memory unit accessible by the user device and displayed on the user device.

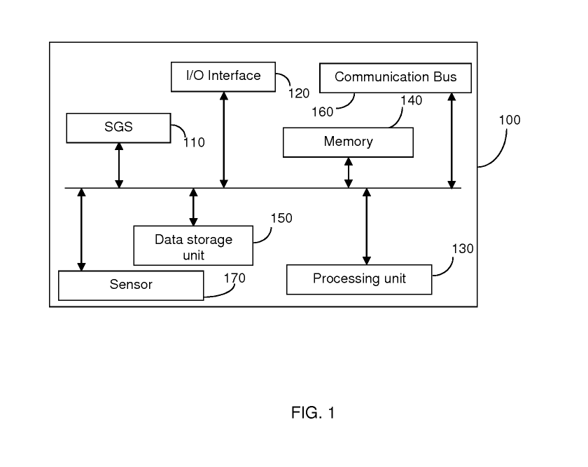

FIG. 1 shows an exemplary and non-limiting schematic diagram of a user device 100 configured to perform the various embodiments disclosed herein. The user device 100 includes an input/output interface (interface) 120, a processing unit 130, a memory 140, a storage unit 150, and a communication bus 160 for connecting the units of the device 100. The user device 100 may further captured by one or more sensors 170. Examples for such sensors 170 may be for example, one or more image sensors (camera), audio sensors, and the like. In certain configurations, the user device may further include a signature generator system (SGS) 110.

The user device 100 may be realized as, for example, a personal computer (PC), a personal digital assistant (PDA), a mobile phone, a smart phone, a tablet computer, a wearable computing device, and other wired and mobile devices equipped with browsing, viewing, listening, filtering, and managing capabilities, etc., that are enabled as further discussed herein below.

The input/output interface (interface) 120 includes, for example, a keyboard, a touch screen, a combination thereof, and the like. The processing unit 130 may include one or more processors. The one or more processors may be implemented with any combination of general-purpose microprocessors, multi-core processors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information. In some implementations the processing unit 130 may implemented using an array of computational cores discussed below. The memory 120 may be, but is not limited to, a volatile memory such as random access memory (RAM), or a non-volatile memory (NVM), such as Flash memory.

In certain configurations, the processing unit 130 may be coupled to the memory 140 via the bus 160. In an embodiment, the memory 140 contains instructions that when executed by the processing unit 130 results in the performance of the methods and processes described herein below. Specifically, the processing unit 130 may include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing unit 130 to perform the various functions described herein.

The storage unit 150 is configured to store multimedia content elements and metadata associated with each such element. The multimedia content elements and their respective metadata may be preloaded to the storage unit 150 and updated based on the queries submitted by the user of the user device 100. The storage unit 150 may further include multimedia content elements captured by any of the sensors 170. A multimedia content element may include, for example, an image, a graphic, a video stream, a video clip, an audio stream, an audio clip, a video frame, a photograph, and an image of signals (e.g., spectrograms, phasograms, scalograms, etc.), and/or combinations thereof and portions thereof. It should be noted that a received multimedia data element may also be a portion of a full image. For example, a logo that is shown on certain television shows, or a cartoon character used in a movie, and the like, may be recognized as a multimedia content element.

The metadata associated with the multimedia content element is a textual description of such element. The metadata may provide a general description of the multimedia content element or items presented in the multimedia content elements. For example, an image showing the Statue of Liberty with a boat in the background, the metadata associated with this image would include description of the Statue of Liberty and the cruise boat that regularly approaches the Statue of Liberty.

In some embodiments, signatures previously generated for the multimedia content elements are also stored in the storage unit 150. Such signatures are typically generated when determining the metadata for the respective element. Techniques for generating metadata for multimedia content elements are discussed in more detail in the co-pending U.S. patent application Ser. No. 12/344,888 referenced above

The storage unit 150 may be a non-volatile memory (NVM), such as a Flash memory or Flash drive, a hard-disk, and the like. In the embodiment illustrated in FIG. 1, the processing unit 130 is configured to communicate with the storage unit 150 directly as they are directly connected on the user device 110. According to an alternative embodiment, the processing unit 130 is configured to communicate with one or more other storage units (or databases) through a network.

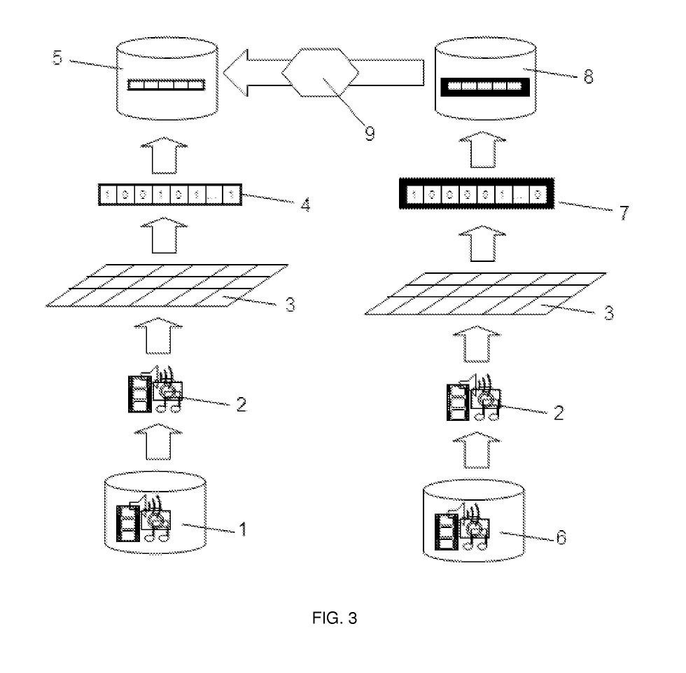

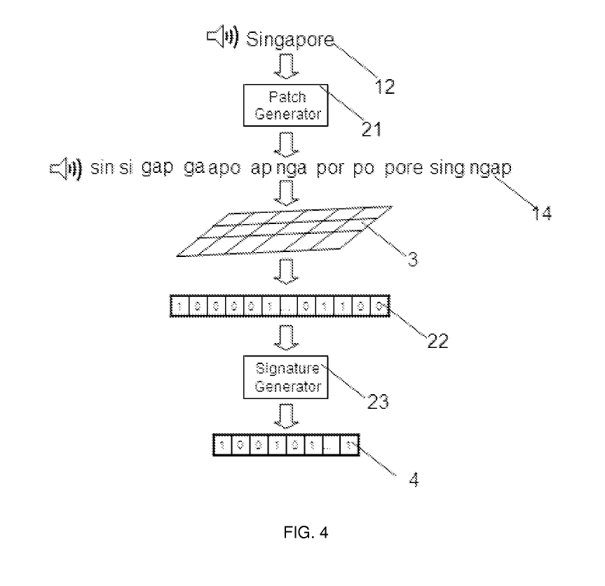

The various embodiments disclosed herein are realized, in part, using the processing unit 130 and the SGS 110. The SGS 110 may be connected to the processing unit 130 directly as it is assembled on the user device 110. In an alternative embodiment, the SGS 110 is connected to the processing unit 130 through a network. The processing unit 130 is configured to receive and serve multimedia content elements via the interface 120 and requests the SGS 110 to generate a signature respective of each such multimedia content element. The process for generating the signatures for multimedia content is explained in more detail herein below with respect to FIGS. 3 and 4. According to an embodiment, the SGS 110 is configured to generate for each multimedia content element provided at least one signature. The generated signature(s) may be robust to noise and distortion as discussed below.

It should be noted that the multimedia content elements provided via the interface 120 are not associated with metadata. Such multimedia content elements will be referred to as “input multimedia content elements” or an “input multimedia content element”.

According to one embodiment, the input multimedia content elements may be captured by the one or more sensors 170 assembled on the user device 110. According to one embodiment, the operation described herein is enabled by an agent (not shown) installed on the user device 100 that configures the processing unit 130 to execute the operation of the user device 100 as described herein below.

According to the disclosed embodiments, the processing unit 130 is configured to receive input multimedia content elements from a user of the user device 100 via the interface 120. The processing unit 130 is further configured to analyze an input multimedia content element based on at least one signature generated for the input multimedia content element.

According to the embodiments disclosed herein, the processing unit 130 is further configured to receive at least one query from the interface 120. The query may be, for example, a user's gesture or a textual input received through the interface 120. The user's gesture may be: a scroll through the input multimedia content element, a press or tap on the multimedia content element, and/or a response to the multimedia content.

According to one embodiment, the query is associated with the at least a portion of the input multimedia content element respective of the type of query. The associations for each type of query may be defined in a predefined list contained in the storage unit 150. For example, a swift gesture may be associated with a dynamic element shown in the multimedia content element. As another example, a two-finger gesture over a video clip may be associated with a request to display images on the interface 120 of the user device 110.

Then, using the generated signature(s) and the query, the processing unit 130 searches the storage unit 150 for multimedia content elements matching the input multimedia content element. In an embodiment, the matching is performed respective of the signatures for the input multimedia content element and the provided query. The query may be utilized to narrow results provided by the matching process. For example, if the processing unit 130 identifies more than one matching elements, than the query can be utilized to select the best matching element.

In an embodiment, a matching between two multimedia content elements is provided respective of their respective signatures. Two multimedia content elements are considered matching if their respective signatures overlap more than a predetermined threshold level.

In one embodiment, metadata associated with a multimedia content element stored in the storage unit 150 that best matches the input multimedia content is retrieved from the storage unit 150 and displayed on the interface 120. In an embodiment, the best matching multimedia content element is also displayed. The displayed metadata provide more information on the input multimedia content element and is indicative of the user's current interest or preferences.

As a non-limiting example, an image of a restaurant menu is captured by a sensor 170 of the user device 100 and provided to the processing unit 130. A double tap over a certain dish, e.g., Greek Salad, in the menu is further received via the interface 120 as a query. The query is interpreted as an interest in the dish. The query may further include data related to the restaurant in order to provide more accurate content. As an example, the data may include the location of the restaurant, type of food served at the restaurant, and so on.

The processing unit 130 then configures the SGS 110 to generate at least one signature for the captured image (input multimedia content element). Then, respective of the signature(s) and the query, the processing unit 130 is configured to find an image or other types of multimedia content element that match the signature of the received image. A matching image would be a different picture of a salad or a Greek Salad. The metadata associated with the matching image is retrieved. As an example the metadata may describe the salad and its ingredients “Greek salad; tomatoes; cucumbers; onion; feta cheese; and olives”. The processing unit 130 is configured to display the metadata and optionally the matching image.

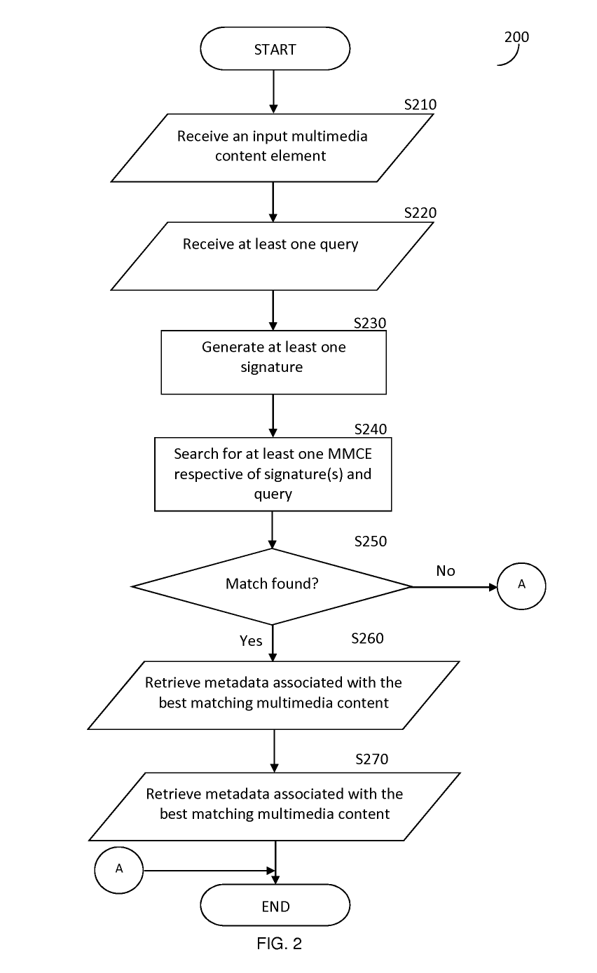

FIG. 2 depicts an exemplary and non-limiting flowchart 200 describing a method for providing content associated with a multimedia content element according to an embodiment. The method may be performed by the user device 100. With limiting the scope of the disclosed embodiment, the method will be discussed with reference to the various elements shown in FIG. 1. In S210, at least one input multimedia content element is received. In an embodiment, such an element is provided by one or more of the sensors 170.

In S220, at least one query is received from a user of the user device 110 by the interface 120 as further described hereinabove with respect of FIG. 1. In S230, at least one signature for the input multimedia content element is generated. The at least one signature for the multimedia content element is generated by a SGS 110 as described below with respect to FIGS. 3 and 4.

In S240, using the generated signature(s) and the at least one query, at least one multimedia content element, stored in the storage unit 150, matching the input multimedia content element is searched for. The operation of S240 is described hereinabove with respect to FIG. 1. In an embodiment, if more than one matching multimedia content element is found, the best matching element is determined respective of the input query. In S250, it is checked if at least one matching signature was found, and if so, execution continues with S260, otherwise, execution terminates.

In S260, the metadata associated with the best matching multimedia content is retrieved from the storage unit 150. In S270, the best matching multimedia content is displayed on the interface 120. In an embodiment, the metadata associated with the best matching multimedia content element is also displayed on the interface 120.

FIGS. 3 and 4 illustrate the generation of signatures for the multimedia content elements by the SGS 110 according to one embodiment. An exemplary high-level description of the process for large scale matching is depicted in FIG. 3. In this example, the matching is for a video content.

Video content segments 2 from a Master database (DB) 6 and a Target DB 1 are processed in parallel by a large number of independent computational cores 3 that constitute an architecture for generating the signatures (hereinafter the “Architecture”). Further details on the computational cores generation are provided below. The independent cores 3 generate a database of Robust Signatures and Signatures 4 for Target content-segments 5 and a database of Robust Signatures and Signatures 7 for Master content-segments 8. An exemplary and non-limiting process of signature generation for an audio component is shown in detail in FIG. 4. Finally, Target Robust Signatures and/or Signatures are effectively matched, by a matching algorithm 9, to Master Robust Signatures and/or Signatures database to find all matches between the two databases.

To demonstrate an example of the signature generation process, it is assumed, merely for the sake of simplicity and without limitation on the generality of the disclosed embodiments, that the signatures are based on a single frame, leading to certain simplification of the computational cores generation. The Matching System is extensible for signatures generation capturing the dynamics in-between the frames.

The Signatures' generation process is now described with reference to FIG. 4. The first step in the process of signatures generation from a given speech-segment is to breakdown the speech-segment to K patches 14 of random length P and random position within the speech segment 12. The breakdown is performed by the patch generator component 21. The value of the number of patches K, random length P and random position parameters is determined based on optimization, considering the tradeoff between accuracy rate and the number of fast matches required in the flow process of the processing unit 130 and SGS 110. Thereafter, all the K patches are injected in parallel into all computational cores 3 to generate K response vectors 22, which are fed into a signature generator system 23 to produce a database of Robust Signatures and Signatures 4.

In order to generate Robust Signatures, i.e., signatures that are robust to additive noise L (where L is an integer equal to or greater than 1) by the computational cores 3 a frame ‘i’ is injected into all the cores 3. Then, cores 3 generate two binary response vectors: \vec{S} which is a signature vector, and \vec{RS} which is a Robust Signature vector.

For generation of signatures robust to additive noise, such as White-Gaussian-Noise, scratch, etc., but not robust to distortions, such as crop, shift and rotation, etc., a core Ci={ni} (1≦i≦L) may consist of a single leaky integrate-to-threshold unit (LTU) node or more nodes. The node ni equations are:

$${V}_{i} = {\sum }_{j} {w}_{ij} {k}_{j}$$

$${n}_{i} = Π ( Vi - {Th}_{x} )$$

where, [symbol] is a Heaviside step function; wᵢⱼ is a coupling node unit (CNU) between node i and image component j (for example, grayscale value of a certain pixel j); kj is an image component ‘j’ (for example, grayscale value of a certain pixel j); Thx is a constant Threshold value, where ‘x’ is ‘S’ for Signature and ‘RS’ for Robust Signature; and Vi is a Coupling Node Value.

The Threshold values Thx are set differently for signature generation and for Robust Signature generation. For example, for a certain distribution of Vi values (for the set of nodes), the thresholds for signature (Ths) and Robust Signature (Th_{RS}) are set apart, after optimization, according to at least one or more of the following criteria:

For:

Vᵢ>Th_{RS}

1−p(V>Th_{S})−1−(1−ε)^{l}<<1 1:

i.e., given that l nodes (cores) constitute a Robust Signature of a certain image I, the probability that not all of these I nodes will belong to the signature of same, but noisy image, Ĩ is sufficiently low (according to a system's specified accuracy).

p(Vᵢ>Th_{RS})≈l/L 2:

i.e., approximately l out of the total L nodes can be found to generate a Robust Signature according to the above definition.

3: Both Robust Signature and Signature are Generated for Certain Frame i.

It should be understood that the generation of a signature is unidirectional, and typically yields lossless compression, where the characteristics of the compressed data are maintained but the uncompressed data cannot be reconstructed. Therefore, a signature can be used for the purpose of comparison to another signature without the need of comparison to the original data. The detailed description of the signature generation can be found in U.S. Pat. Nos. 8,326,775 and 8,312,031, assigned to common assignee, which are hereby incorporated by reference for all the useful information they contain.

A computational core generation is a process of definition, selection, and tuning of the parameters of the cores for a certain realization in a specific system and application. The process is based on several design considerations, such as:

(a) The cores should be designed so as to obtain maximal independence, i.e., the projection from a signal space should generate a maximal pair-wise distance between any two cores' projections into a high-dimensional space.

(b) The cores should be optimally designed for the type of signals, i.e., the cores should be maximally sensitive to the spatio-temporal structure of the injected signal, for example, and in particular, sensitive to local correlations in time and space. Thus, in some cases a core represents a dynamic system, such as in state space, phase space, edge of chaos, etc., which is uniquely used herein to exploit their maximal computational power.

(c) The cores should be optimally designed with regard to invariance to a set of signal distortions, of interest in relevant applications.

In some implementations the processing unit 130 may be implemented using an array of computational cores. A detailed description of the computational core generation and the process for configuring such cores is discussed in more detail in the U.S. Pat. No. 8,655,801 referenced above.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiments and the concepts contributed by the inventor to furthering the art, and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for determining current preferences of a user of a user device, comprising:
receiving at least one input multimedia content element from the user device;
receiving at least one query;
generating at least one signature respective of the at least one input multimedia content element;
searching a storage unit for a multimedia content element matching the at least one input multimedia content element, wherein the matching is performed respective of the at least one generated signature and the at least one query;
retrieving metadata associated with the matching multimedia content element, wherein the metadata implies the current preferences of the user; and
displaying the metadata on a display of the user device.

2. The method of claim 1, further comprising:
displaying the matching multimedia content element on a display of the metadata.

3. The method of claim 1, wherein searching for the matching multimedia content element further comprises:
comparing the at least one generated signature for each signature previously generated for each of the multimedia content element stored in the storage unit; and
determining a multimedia content element as a matching multimedia content element if its respective signature overlaps the at least one generated signature more than a predetermined threshold level.

4. The method of claim 1, wherein the metadata is a textual description of the matching multimedia content element, or portions thereof.

5. The method of claim 1, wherein the at least one multimedia content element is received from at least one sensor of the user device.

6. The method of claim 5, wherein the at least one sensor is at least one of: an image sensor and audio sensor.

7. The method of claim 1, wherein the at least one signature is robust to noise and distortion.

8. The method of claim 1, wherein the multimedia content element is at least one of: an image, graphics, a video stream, a video clip, an audio stream, an audio clip, a video frame, a photograph, images of signals, and portions thereof.

9. The method of claim 1, wherein the query is at least one of: a gesture, a textual input query.

10. The method of claim 9, wherein the gesture is at least one of: a scroll through the input multimedia content element, a tap on the multimedia content element, and a response to the multimedia content.

11. The method of claim 1, wherein the at least one signature is generated by a signature generator system (SGS), wherein the SGS comprises: a plurality of computational cores enabled to receive the at least a multimedia content element, each computational core of the plurality of computational cores having properties that are at least partly statistically independent of other of the computational cores, the properties are set independently of each other core.

12. A non-transitory computer readable medium having stored thereon instructions for causing one or more processing units to execute the method according to claim 1.

13. A system for determining current preferences of a user of a user device, comprising:
an interface;
a storage unit;
a processing unit;
a memory, the memory contains therein instructions that when executed by the processing unit configures the system to:
receive by the interface at least one input multimedia content element from the user device;
receive at least one query;
search a storage unit for a multimedia content element matching the at least one input multimedia content element, wherein the matching is performed respective of the at least one generated signature and the at least one query;
retrieve metadata associated with the matching multimedia content element, wherein the metadata implies the current preferences of the user; and,
display the metadata on a display of the user device.

14. The system of claim 13, further configured to:
display the matching multimedia content element on a display of the metadata.

15. The system of claim 13, wherein searching for the matching multimedia content element further comprises:
comparing the at least one generated signature for each signature previously generated for each of the multimedia content element stored in the storage unit; and
determining a multimedia content element as a matching multimedia content element if its respective signature overlaps the at least one generated signature more than a predetermined threshold level.

16. The system of claim 13, wherein the metadata is a textual description of the matching multimedia content element, or portions thereof.

17. The system of claim 13, wherein the at least one multimedia content element is received from at least one sensor of the user device.

18. The system of claim 17, wherein the at least one sensor is at least one of: an image sensor and audio sensor.

19. The system of claim 13, wherein the at least one signature is robust to noise and distortion.

20. The system of claim 13, wherein the multimedia content element is at least one of: an image, graphics, a video stream, a video clip, an audio stream, an audio clip, a video frame, a photograph, images of signals, and portions thereof.

21. The system of claim 13, wherein the query is at least one of: a gesture, a textual input query.

22. The system of claim 21, wherein the gesture is at least one of: a scroll through the input multimedia content element, a tap on the multimedia content element, and a response to the multimedia content.

23. The system of claim 13, further comprising:
a signature generator system comprising a plurality of computational cores enabled to receive the at least a multimedia content element, each computational core of the plurality of computational cores having properties that are at least partly statistically independent of other of the computational cores, the properties are set independently of each other core.
